(19) United States
(12) Patent Application Publication
(10) Pub. No.: US 2010/0089858 A1
(43) Pub. Date: Apr. 15, 2010

(54) CONVERTIBLE BABY FEEDING BOTTLE FOR USE WITH OR WITHOUT A DISPOSABLE BAG

(76) Inventor: Tara Karen Jones-Francis, Brooklyn, NY (US)

Correspondence Address: MICHAEL RIES, 318 PARKER PLACE, OSWEGO, IL, 60543, US

(21) Appl. No.: 12/577,013

(22) Filed: Oct. 9, 2009

Related U.S. Application Data
(60) Provisional application No. 61/104,020, filed on Oct. 9, 2008.

(51) Int. Cl. A61J 9/00

(52) U.S. Cl. 215/11.1

(57) ABSTRACT

A baby feeding bottle which is capable of being used either with or without a disposable bag, has a hollow cylindrical elongated body that defines an inner chamber and a circular opening at each end. A first cap is provided which includes a nipple which is capable of covering one opening at an end of the cylindrical body by being twisted onto the elongated body. A second cap is provided which is capable of being twisted onto the other end of the elongated body for forming a leak resistant covering with the other opening.

This patent application claims the benefit of U.S. Provisional Application No. 61/104,020 filed on Oct. 9, 2008, the disclosure of which is incorporated herein in its entirety by reference.

### BACKGROUND OF THE INVENTION

1. Field of the Invention

The present invention relates generally to a baby feeding bottle and more specifically to a cylindrically shaped feeding bottle for use with or without a disposable bag that has substantially equal sized openings at each end of the cylindrically shaped bottle and where each end of the bottle has threads for receiving either a twist on cap which includes a nipple or a leak resistant twist on cap

2. Description of Related Art

Conventional feeding bottles for holding and providing a liquid such as milk, water, etc. for feeding a baby are typically cylindrical in shape with a closed bottom and a narrow opening at the top having threads for receiving a removable cap with a nipple. Also known are feeding bottles that have a closed bottom and a removable cap with a nipple where the fluid in the bottle is in a disposable bag.

For example, U.S. Pat. No. 5,579,935 by Atkin et al. discloses a baby feeding bottle of the disposable bag type where the bottom of the filled bag is supported by a removable base which is inserted in the open bottom end of the bottle.

U.S. Pat. No. 5,356,016 to Wiedemann discloses a nursing bottle having a disposable bag and a plunger for eliminating air that is present in the disposable bag.

U.S. Pat. No. 5,301,825 to Di Scala et al. discloses a nursing bottle having a flexible liner and a ring/disc combination which is used to eliminate air within the flexible liner.

Most prior art bottles that use disposable bags have members that press fit into the bottom of the nursing bottle, but some nursing bottles have bottom members that are removal such as is disclosed in U.S. Pat. No. 4,821,896 to Cheng which shows a baby bottle having a removable bottom that includes a vent for allowing air to flow into the bottle.

None of the nursing bottles which use a disposable bag have top and bottom openings which are substantially equal in size where each opening is adapted to receive either a top cap having a nursing nipple or a bottom leak resistant cap. In addition, both caps can be removed when cleaning the bottle and, when desired, the nursing bottle can be used either with or without a disposable bag for holding a liquid such as milk, water, juice etc.

### SUMMARY OF THE INVENTION

In an exemplary embodiment of the present invention, there is disclosed a baby feeding bottle which is capable of being used either with or without a disposable bag. The bottle has a hollow cylindrical elongated body that defines an inner chamber and a circular opening at each end. A first cap is provided which includes a nipple which is capable of covering one opening at an end of the cylindrical body by being twisted onto the elongated body. A second cap is provided which is capable of being twisted onto the other end of the elongated body for forming a leak resistant covering with the other opening.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an exploded view of a cylindrically shaped baby feeding bottle having a top cap and nipple, a disposable bag and a removable leak resistant bottom cap in accordance with the principles of the invention;

FIG. 2 is a side view of the baby feeding bottle in use with a disposable bag without the bottom cap being attached to the bottle; and

FIG. 3 is a side view of the baby feeding bottle in use without the disposable bag and with a leak resistant bottom cap attached to the bottle in accordance with the principles if the invention.

### DESCRIPTION OF THE PREFERRED EMBODIMENT

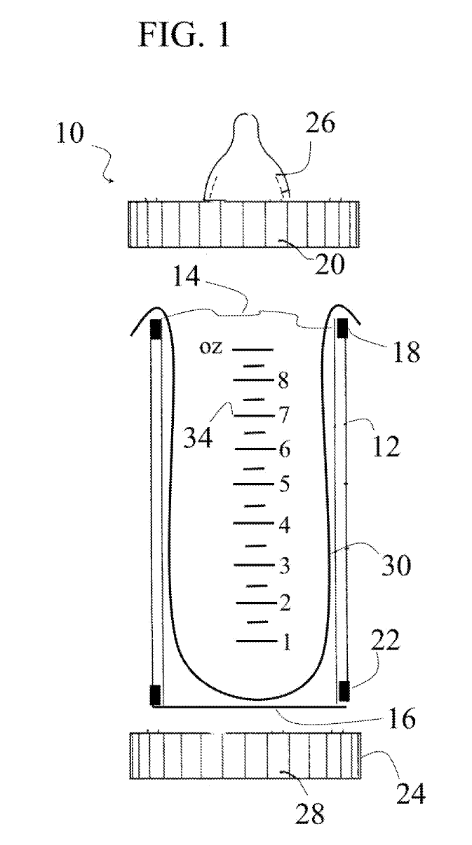

Referring to FIG. 1, there is shown an exploded view of a cylindrically shaped baby feeding bottle 10 having a top cap and nipple, a disposable bag and a removable leak resistant bottom cap in accordance with the principles of the invention.

The baby feeding bottle 10 has a main body portion that has a hollow cylindrical shaped elongated body 12 with a circular open top portion 14 and a circular open bottom portion 16. The openings at the top and bottom of the cylinder are substantially equal in size. Located at the top opening 14 and on the outside of the cylindrical body 12 is a screw thread 18 which provides for receiving a screw thread located on the inside surface of cap 20. Located at the bottom opening 16 and on the outside of the cylindrical body 12 are screw threads 22 which are provided for receiving internally located screw threads on cap 24.

The top of cap 20 includes a centrally located opening for receiving a nipple 26 which is composed of a soft material such as rubber or plastic and which includes at its top end a small opening through which liquid can pass. The inside surface of the sides of cap 20 has screw threads which mate with the external screw threads 18 on the outside surface of the cylindrical body 12. The cap and nipple form a leak resistant seal with the top of cylindrical body 12 when the cap 20 is screwed onto the threads 18 on the cylindrical body.

Cap 24 has a continuous bottom surface 28 and its sides has internally located screw threads that mate with the threads 22 on the outside surface at the bottom of cylindrical body 12. A leak resistant seal is formed when the cap 24 is screwed onto the bottom of the cylindrical body.

The threads 18 and 22 on the end portions of the cylindrical body are similar and, therefore, cap 20 can be threaded onto threads 18 or 22. In a similar manner, cap 24 can be threaded onto threads 18 or 22. Thus, either cap 20 or cap 24 can be threaded onto either end of the cylindrical shaped body 12. The cylindrical body 12 has an inside diameter which is sufficient to receive a disposable bag 30.

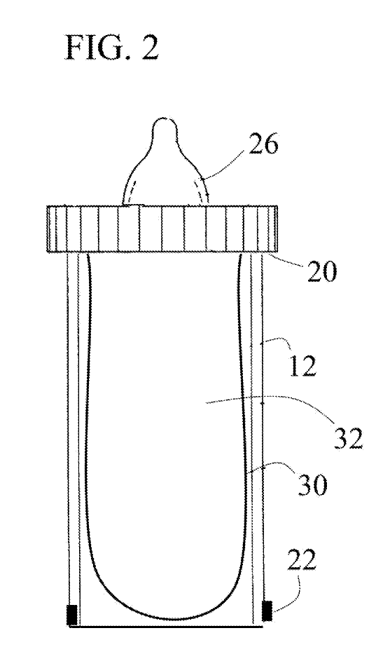

Referring to FIG. 2, when the cylindrically shaped baby feeding bottle 10 is being used as a nursing bottle for a very young baby, a disposable bag 30 can be inserted into an end of the cylinder 12 and the open end of the disposable bag is wrapped over the top edge of the cylindrical body 12. The disposable bag is then filled with a desired liquid 32 such a formula, and the cap 20 together with the nipple 26 is then threaded onto the end of the cylindrical body to form a leak proof seal. If the bottle is to be used at this time, cap 24 is either not threaded onto the bottom end of the bottle as shown in FIG. 2, or the cap 24 can be loosely threaded onto the end of the cylindrical body. If the cap 24 is threaded onto the cylinder while the bottle is being used to feed a baby, it must remain loose to allow air to enter the cylindrical body as the liquid in the disposable bag is being removed.

If, after the disposable bag is filled with a liquid such as a formula and the bottle is not going to be used immediately, the cap 24 can then be threaded tightly onto the bottom of the bottle. However, prior to being used the cap 24 must be either loosened or removed to allow air to enter the bottle as the liquid in the disposable bag is removed. As noted above, the two ends of the cylindrically shaped body 12 are substantially similar and cap 20 with the nipple can be threaded onto the end 14 or the end 16.

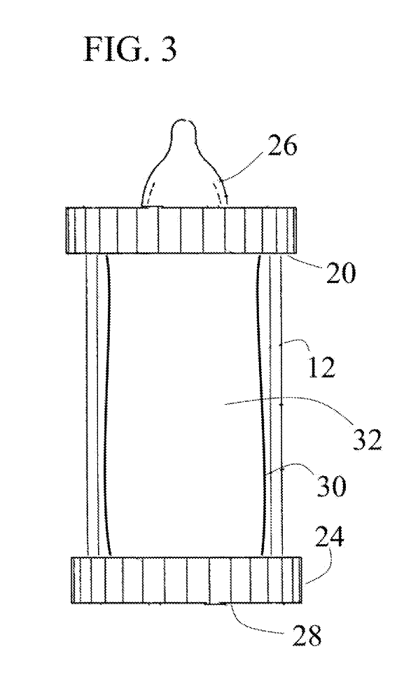

The convertible feeding bottle 10 here disclosed can be used with a disposable bag or without a disposable bag. It in not limited to being used only with a disposable bag. Referring to FIG. 3, to use the feeding bottle without a disposable bag, after the cylindrical body 12 is washed and dried, cap 24 is threaded tightly onto either end of cylindrical body 12. The body is then filled with a desired fluid 32 such as a formula, milk, water, etc., and the cap 20 with the nipple 26 is then threaded tightly onto the open end of the cylindrical body. The feeding bottle is now ready for use by a child.

After the nursing bottle has been used, either with or without a disposable bag, the cap 20 with the nipple 26 is unscrewed from the body 12 and the cap 24 is unscrewed from the body. The nipple 26 is removed from the cap 20 and the various parts are cleaned and sterilized. The body 12 can be easily cleaned and sterilized without requiring a brush or repeated rinsing because the cylindrical body is open at each end. It does not have a bottom that is sealed.

The cylindrical body 12 can be made of a clear or opaque glass or plastic and, when made of plastic, the body 12 can colored with the traditional color of blue for boys or pink for girls. In addition, the cylindrical body can include ounce measure lines and numbers 34, see FIG. 1, to show the amount of fluid that is in the nursing bottle at any specific time.

The convertible baby feeding bottle here disclosed can be used either with or without a disposable bag. The bottle consists of four parts, a top cap which includes a nipple, a bottom cap, and a cylindrical shaped body that is open at each end. In one embodiment of the invention the openings at each end have similar dimensions which allows either cap to be threaded onto either end of the cylindrical body. In use, the cap is not placed on the bottom of the convertible baby feeding bottle, or is loosely placed on the bottom opening when the bottle is used with a disposable bag.

When the convertible baby feeding bottle is not used with a disposable bag, cap 24 is threaded tightly onto the bottom of the cylindrical body to make a leak proof seal. Thus, when the cap 24 is threaded onto the bottom of the cylindrical body, the bottle is converted from a bottle that uses a disposable bag to a standard baby feeding bottle.

The convertible baby feeding bottle here disclosed is easy to clean and sterilize because it has an opening at each end. In addition, by being convertible from a bottle that uses disposable bags to a standard baby feeding bottle, a parent can save money and reduce the amount of bottle usage for the baby.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A convertible baby feeding bottle comprising:
a hollow cylindrical elongated body that defines an inner surface and an outer surface and respective circular first and second end portions;
said first circular end portion having an open top portion;
a first cap capable of being attached to said open top portion of said first circular end portion;
said second circular end portion having an open bottom portion; and
a second cap capable of being attached to said open bottom portion of said second circular end portion.

2. The convertible baby feeding bottle of claim 1 wherein said first cap is adapted to receive a nipple.

3. The convertible baby feeding bottle of claim 1 wherein said second cap is capable of sealing said second circular end portion.

4. The convertible baby feeding bottle of claim 1 wherein said hollow cylindrical elongated body is capable of receiving a disposable bag.

5. The convertible baby feeding bottle of claim 2 wherein said first cap is removably attached to said open top portion of said first circular end portion.

6. The convertible baby feeding bottle of claim 3 wherein said second cap is removably attached to said open bottom portion of said second circular end portion.

7. The convertible baby feeding bottle of claim 1 wherein said first and second circular end portions have substantially equal dimensions.

8. The convertible baby feeding bottle of claim 7 wherein said first cap can be attached to either of said first or second circular end portions.

9. The convertible baby feeding bottle of claim 7 wherein said second cap can be attached to either of said first or second circular end portions.

10. The convertible baby feeding bottle of claim 4 wherein when a disposable bag capable of receiving a liquid is located within said hollow cylindrical elongated body said second cap in not attached to said open bottom portion of said second circular end portion.

11. The convertible baby feeding bottle of claim 4 wherein when a disposable bag capable of receiving a liquid is located within said hollow cylindrical elongated body said second cap in loosely attached to said open bottom portion of said second circular end portion.

12. The convertible baby feeding bottle of claim 4 wherein when a disposable bag capable of receiving a liquid is not located within said hollow cylindrical elongated body said second cap is threaded onto the second circular end portion to provide a leak resistant coupling.

13. The convertible baby feeding bottle of claim 1 wherein said first cap is capable of being screwed to said open top portion of said first circular end portion or to said open bottom portion of said second circular end portion.

14. The convertible baby feeding bottle of claim 1 wherein said second cap is capable of being screwed to said open top portion of said first circular end portion or to said open bottom portion of said second circular end portion.
